(19) United States
(12) Patent Application Publication
(10) Pub. No.: US 2024/0183808 A1
(43) Pub. Date: Jun. 6, 2024

(54) DEVICE AND METHOD FOR MEASURING THERMAL CONDUCTIVITY OF HIGH-TEMPERATURE AND HIGH-PRESSURE LIQUID

(71) Applicant: Beihang University, Beijing (CN)

(72) Inventors: Yanchen FU, Beijing (CN); Guoqiang XU, Beijing (CN); Jie WEN, Beijing (CN); Yongkai QUAN, Beijing (CN); Han QI, Beijing (CN); Weitong LIU, Beijing (CN); Yinlong LIU, Beijing (CN)

(73) Assignee: Beihang University, Beijing (CN)

(21) Appl. No.: 18/531,145

(22) Filed: Dec. 6, 2023

(30) Foreign Application Priority Data
Dec. 6, 2022 (CN) 202211578499.5

(51) Int. Cl. G01N 25/20; G01K 13/02; G01K 19/00

(52) U.S. Cl. CPC G01N 25/20; G01K 13/026; G01K 19/00

(57) ABSTRACT

A device for measuring a thermal conductivity of high-temperature and high-pressure liquid is provided and includes a probe and a liquid flow channel, the probe radially penetrates through the liquid flow channel, both ends of the probe extend out of the liquid flow channel and are connected to a control system via wires; the control system includes a power supply, a voltmeter, an ammeter, a thermocouple and a flowmeter, which are used for energizing the probe, measuring voltage at both ends of the probe, measuring current flowing through the probe, measuring temperature of and a flow velocity of the liquid, respectively. A measuring method is further provided. The device and the method for measuring the thermal conductivity of high-temperature and high-pressure liquid utilize a principle of heat balance and characteristics of liquid sweeping across a circular tube for measurement when the liquid enters a fully developed section.

### CROSS-REFERENCE TO RELATED APPLICATION

This patent application claims the benefit and priority of Chinese Patent Application No. 20-2211-578499.5 filed with the China National Intellectual Property Administration on Dec. 6, 2022, the disclosure of which is incorporated by reference herein in its entirety as part of the present application.

### TECHNICAL FIELD

The present disclosure relates to a measuring device and a measuring method, in particular to a device and a method for measuring a thermal conductivity of high-temperature and high-pressure liquid.

### BACKGROUND

Experimental methods for measuring a thermal conductivity of liquid can be divided into a steady-state method and a transient method. A transient hot wire method is considered to be one of the most reliable methods for measuring the thermal conductivity of fluid because of its simple experimental principle and fast speed of measurement. However, the measurement process of the transient hot wire method will introduce errors resulted from convection heat transfer and radiation heat transfer, and the device used in the transient hot wire method has a complex structure and has the characteristics that the hot wire is thin in diameter and easy to fracture, which is not conducive to use and popularization.

In order to optimize the measurement method of thermal conductivity, researchers put forward many improved methods based on the principle of the transient method, including a transient double-line method and a steady-state heat source method, which further expands the measurement accuracy and the measurable temperature range of thermal conductivity. However, there is still a lack of a measurement method with a high accuracy and a simple principle and a corresponding experimental device with good economy and easy popularization for liquid working at high temperature and high pressure, such as aviation kerosene.

### SUMMARY

The present disclosure aims to overcome the existing defects, provide a device and a method for measuring a thermal conductivity of high-temperature and high-pressure liquid, and solve the problems, such as large errors in the current measurement method, complex structure of the measuring device, and easy damage to components.

In order to solve the above technical problems, the present disclosure provides the following technical scheme.

A device for measuring a thermal conductivity of high-temperature and high-pressure liquid is provided, including a probe and a liquid flow channel, wherein the probe radially penetrates through the liquid flow channel, both ends of the probe extend out of the liquid flow channel and are installed and fixed via installation components, and both ends of the probe are connected to a control system via wires;

the control system includes a power supply, a voltmeter, an ammeter, a thermocouple and a flowmeter, wherein the power supply is used for energizing the probe, the voltmeter is used for measuring voltage at both ends of the probe, the ammeter is used for measuring current flowing through the probe, the thermocouple is used for measuring temperature of the liquid, and the flowmeter is used for measuring a flow velocity of the liquid.

In some embodiments, the probe is made of tungsten metal or platinum metal and has a diameter of a range from 0.05 mm to 1 mm.

In some embodiments, the installation component includes an adiabatic screw head, an end of the probe is inserted into the adiabatic screw head, a top of the adiabatic screw head is provided with a wiring hole, an outer side of the adiabatic screw head is sheathed with an alumina ceramic insulating shell, an outer side of the alumina ceramic insulating shell is sheathed with a metal shell, an external thread is formed on a lower end of the metal shell, and the lower end of the metal shell is in threaded connection with an internal thread hole preset on the liquid flow channel.

In some embodiments, a ratio of a length to a diameter of the liquid flow channel is not less than 15:1, and a distance between a position where the probe penetrates through the liquid flow channel and an entrance of the liquid flow channel is not less than 2/3 of a length of the liquid flow channel.

A method for measuring a thermal conductivity of high-temperature and high-pressure liquid is provided, wherein a device for measuring a thermal conductivity of high-temperature and high-pressure liquid described above is used, and the method includes steps of:
a, calibrating a temperature coefficient of resistance of the probe according to the material of the probe;
b, installing the probe in the liquid flow channel by using the installation components, and sealing and fastening the probe;
c, connecting the probe with the control system via the wires, and starting the control system to energize the probe and keep current constant;
d, controlling the measured liquid to flow into the liquid flow channel and flow through the probe at a constant flow velocity, and keeping temperature and pressure unchanged during the controlling;
e, after data is stable, recording a voltage value, a current value and a liquid temperature value, and calculating and obtaining a resistance value according to the voltage value and the current value;
f, combining with a mathematical model to calculate and obtain the thermal conductivity of the measured liquid;

the mathematical model includes:

an equation of an average surface heat transfer coefficient of liquid on a surface of the probe:

Nu=C·ReⁿPr^{1/3}

where constants C and n are constants related to a flow environment and Reynolds number in a heat transfer criterion number equation, experimental calibration values are selected and substituted for calculation,

$$Re = \frac{ρ u d}{μ}$$

is a dimensionless number that describes characteristics of liquid flow, and

$$P r = \frac{μ {C}_{p}}{λ}$$

is a dimensionless number that reflects interaction between energy and momentum transfer processes in fluid, which is determined by liquid physical parameters at a qualitative temperature;

according to a principle of heat balance, an amount of heat dissipation of a tungsten wire probe is equal to all heat generated due to flowing of the current through the probe without considering radiation heat transfer, and a heat dissipation equation is:

Q_{dissipation}=h·A·(T_{w-}T_{f})=I_{w}²R_{w}

where h is a convection heat transfer coefficient of a tungsten wire, A is a surface area of the liquid in contact with the probe, T_{w} is a surface temperature of the tungsten wire probe, T_{f} is a temperature of the liquid, I_{w} is current flowing through the probe, and R_{w} is a resistance value in a tungsten metal experiment;

a Nusselt number

$${N}_{μ} = \frac{h d}{λ}$$

is also known, where λ is a thermal conductivity of the fluid, and the equations are sorted to obtain:

$$C \cdot ( \frac{p u d}{μ} ) n {( \frac{μ c p}{λ} )}^{\frac{1}{3}} = \frac{\frac{{I}_{w}^{2} {R}_{w}}{A \cdot ( {T}_{w} - {T}_{f} )} d}{λ}$$

during measurement, a flow velocity u is measured by a flowmeter, a resistance value of the probe at this time is calculated by voltage and current signals in the control system, a the temperature T_{w} at this time is conversed according to a corresponding relationship between a temperature and a resistance, a liquid temperature T_{f} is taken as a measurement temperature of a thermocouple at the entrance, the qualitative temperature

$${T}_{d} = \frac{- {T}_{f} + {T}_{w}}{2}$$

is taken, after finding a physical parameter density ρ, a viscosity μ and a specific heat capacity Cₚ corresponding to the liquid to be measured at this qualitative temperature, only the thermal conductivity λ is left to be solved in the above equation, and the thermal conductivity λ is obtained by substituting the current and the resistance value.

In some embodiments, the device for measuring the thermal conductivity of high-temperature and high-pressure liquid described above is used for calibration by using water or n-decane, and an empirical equation and corresponding constants C and n which are more suitable for fine tungsten wires are obtained by fitting, so as to be used for calculation during measurement of high-temperature and high-pressure liquid.

The device and the method for measuring the thermal conductivity of high-temperature and high-pressure liquid provided by the present disclosure utilize a principle of heat balance and characteristics of liquid sweeping across a circular tube for measurement when the liquid enters a fully developed section, and do not need to construct transient conditions, thus reducing errors and improving accuracy. A tungsten wire metal probe with a diameter of a range from 0.05 mm to 1 mm is used during measurement, so that the problem that filaments are easy to fracture is avoided. The device is simple in structure, fast in the speed of measurement and easy to manufacture and popularize.

### BRIEF DESCRIPTION OF THE DRAWINGS

The accompanying drawings are used to provide a further understanding of the present disclosure and constitute a part of the specification. Together with the embodiments of the present disclosure, the accompanying drawings serve to explain the present disclosure and do not constitute a limitation of the present disclosure. In the accompanying drawings:

FIG. 1 is a schematic front view of the present disclosure (excluding a control system).

FIG. 2 is a schematic side view of the present disclosure (excluding a control system).

FIG. 3 is a schematic structural view of an installation component in the present disclosure.

### DETAILED DESCRIPTION OF THE EMBODIMENTS

Preferred embodiments of the present disclosure will be described below with reference to the accompanying drawings. It should be understood that the preferred embodiments described here are only used to illustrate and explain the present disclosure, rather than limit the present disclosure.

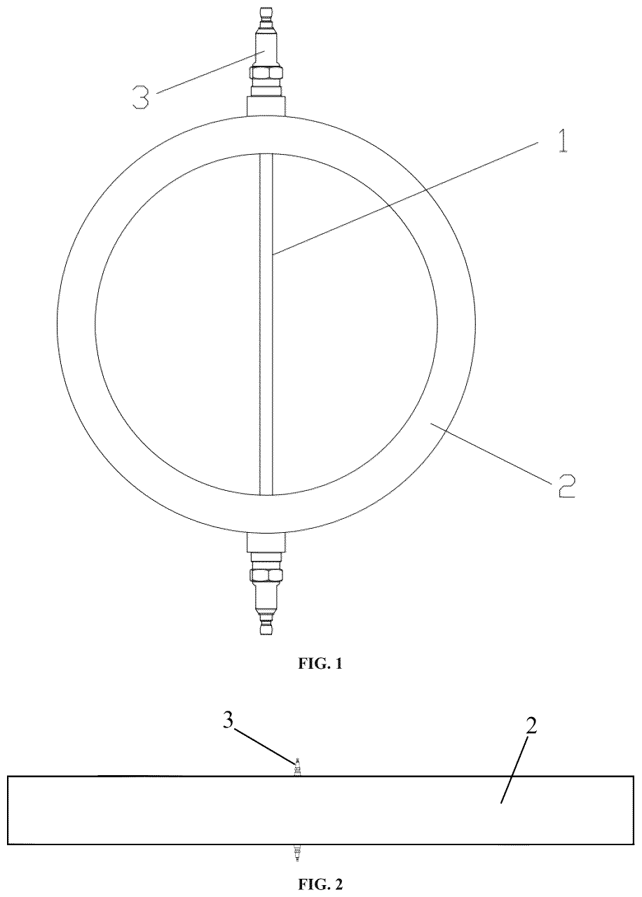

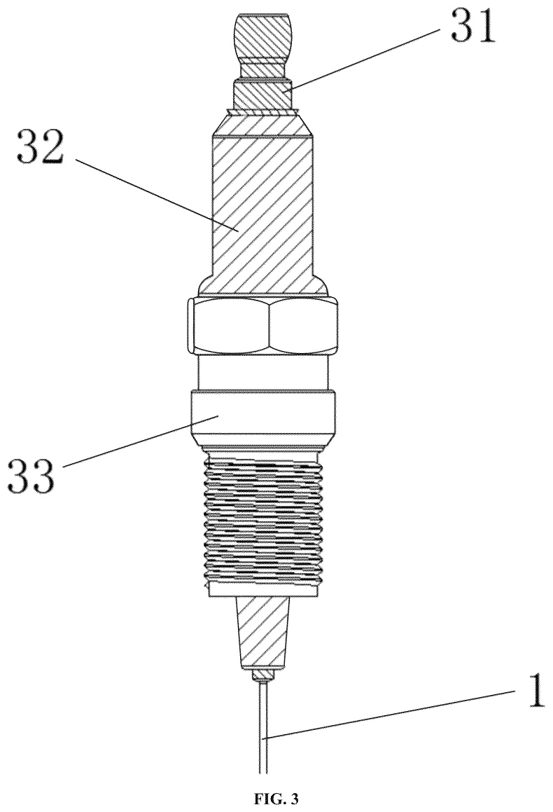

As shown in FIGS. 1 to 3, a device for measuring a thermal conductivity of high-temperature and high-pressure liquid includes a probe 1 and a liquid flow channel 2, wherein the probe 1 radially penetrates through the liquid flow channel 2, both ends of the probe 1 extend out of the liquid flow channel 2 and are installed and fixed via installation components 3, and both ends of the probe 1 are connected to a control system via wires (not shown in the figure).

The control system includes a power supply, a voltmeter, an ammeter, a thermocouple and a flowmeter, wherein the power supply is used for energizing the probe, the voltmeter is used for measuring voltage at both ends of the probe, the ammeter is used for measuring current flowing through the probe, the thermocouple is used for measuring temperature of the liquid, and the flowmeter is used for measuring a flow velocity of the liquid. The control system can achieve the above functions, and the specific connection mode belongs to the conventional technical means of those skilled in the art.

The probe 1 is made of tungsten metal or platinum metal and has a diameter of a range from 0.05 mm to 1 mm, which avoids the problem that filaments are easy to fracture in the traditional hot wire method.

The installation component 3 includes an adiabatic screw head 31. An end of the probe 1 is inserted into the adiabatic screw head 31. A top of the adiabatic screw head 31 is provided with a wiring hole. An outer side of the adiabatic screw head 31 is sheathed with an alumina ceramic insulating shell 32. An outer side of the alumina ceramic insulating shell 32 is sheathed with a metal shell 33. An external thread is formed on a lower end of the metal shell 33. The lower end of the metal shell 33 is in threaded connection with an internal thread hole preset on the liquid flow channel 2.

The adiabatic screw head is used to fix the probe. The heat loss can be reduced and the accuracy can be improved by using thermal insulation materials. The alumina ceramic insulating shell can prevent the probe from being conductive with the liquid flow channel or the metal shell after being energized and affecting the measurement result. The metal shell can ensure the connection strength and prolong the service life.

A ratio of a length to a diameter of the liquid flow channel 2 is not less than 15:1, and a distance between a position where the probe 1 penetrates through the liquid flow channel 2 and an entrance of the liquid flow channel 2 is not less than 2/3 of a length of the liquid flow channel 2. The liquid flows a long enough distance before being in contact with the probe to ensure that the liquid enters the fully developed section, avoid the errors resulted from the change of a boundary layer and improve the measurement accuracy.

A method for measuring a thermal conductivity of high-temperature and high-pressure liquid is provided, wherein a device for measuring a thermal conductivity of high-temperature and high-pressure liquid described above is used, and the method includes steps of:
a, calibrating a temperature coefficient of resistance of the probe according to the material of the probe;
b, installing the probe in the liquid flow channel by using the installation components, and sealing and fastening the probe;
c, connecting the probe with the control system via the wires, and starting the control system to energize the probe and keep current constant;
d, controlling the measured liquid to flow into the liquid flow channel and flow through the probe at a constant flow velocity (valves and fluid conveying pipes can be installed at both ends of the liquid flow channel according to the actual situation), and keeping temperature and pressure unchanged during the controlling;
e, after data is stable, recording a voltage value, a current value and a liquid temperature value, and calculating and obtaining a resistance value according to the voltage value and the current value;
f, combining with a mathematical model to calculate and obtain the thermal conductivity of the measured liquid;

the mathematical model includes:

an equation of an average surface heat transfer coefficient of liquid on a surface of the probe:

Nu=C·ReⁿPr^{1/3}

where constants C and n are constants related to a flow environment and Reynolds number in a heat transfer criterion number equation, experimental calibration values are selected

and substituted for calculation,

$$Re = \frac{ρ u d}{μ}$$

is a dimensionless number that describes characteristics of liquid flow, and

$$P r = \frac{μ {C}_{p}}{λ}$$

is a dimensionless number that reflects interaction between energy and momentum transfer processes in fluid, which is determined by liquid physical parameters at a qualitative temperature;

for the above equation, the device for measuring the thermal conductivity of high-temperature and high-pressure liquid described above is used for calibration by using water or n-decane, and an empirical equation and corresponding constants C and n which are more suitable for fine tungsten wires are obtained by fitting, so as to be used for calculation during measurement of high-temperature and high-pressure liquid;

according to a principle of heat balance, an amount of heat dissipation of a tungsten wire probe is equal to all heat generated due to flowing of the current through the probe without considering radiation heat transfer, and a heat dissipation equation is:

Q_{dissipation}=h·A·(T_{w}−T_{f})=I_{w}²R_{w}

where h is a convection heat transfer coefficient of a tungsten wire, A is a surface area of the liquid in contact with the probe, T_{w} is a surface temperature of the tungsten wire probe, T_{f} is a temperature of the liquid, I_{w} is current flowing through the probe, and R_{w} is a resistance value in a tungsten metal experiment;

a Nusselt number

$${N}_{μ} = \frac{h d}{λ}$$

is also known, where λ is a thermal conductivity of the fluid, and the equations are sorted to obtain:

$$C \cdot ( \frac{p u d}{μ} ) n {( \frac{μ c p}{λ} )}^{\frac{1}{3}} = \frac{\frac{{I}_{w}^{2} {R}_{w}}{A \cdot ( {T}_{w} - {T}_{f} )} d}{λ}$$

during measurement, a flow velocity u is measured by a flowmeter, a resistance value of the probe at this time is calculated by voltage and current signals in the control system, the temperature T_{w} at this time is conversed according to a corresponding relationship between a temperature and a resistance, a liquid temperature T_{f} is taken as a measurement temperature of a thermocouple at the entrance, the qualitative temperature

$${T}_{d} = \frac{- {T}_{f} + {T}_{w}}{2}$$

is taken, after finding a physical parameter density ρ, a viscosity μ and a specific heat capacity Cₚ corresponding to the liquid to be measured at this qualitative temperature, only the thermal conductivity λ is left to be solved in the above equation, and the thermal conductivity λ is obtained by substituting the current and the resistance value.

The above measurement process can be repeated many times without changing the conditions to reduce accidental errors.

During measurement, the numerical calculation in the measurement method and the experimental device can be carried out by using ANSYS FLUENT software, and the two-way verification can be carried out with the experimental results. By continuously optimizing the experimental process and the numerical calculation method and iterating the numerical calculation and experimental results for many times, the empirical equation of the Nusselt number suitable for high-temperature and high-pressure liquid is finally obtained, and the calculation accuracy similar to that of the traditional method is achieved.

The device and the method for measuring the thermal conductivity of high-temperature and high-pressure liquid provided by the present disclosure utilize a principle of heat balance and characteristics of liquid sweeping across a circular tube for measurement when the liquid enters a fully developed section, and do not need to construct transient conditions, thus reducing errors and improving accuracy. A tungsten wire metal probe with a diameter of a range from 0.05 mm to 1 mm is used during measurement, so that the problem that filaments are easy to fracture is avoided. The device is simple in structure, fast in the speed of measurement and easy to manufacture and popularize.

Finally, it should be explained that the above is only the preferred embodiment of the present disclosure, and it is not used to limit the present disclosure. Although the present disclosure has been described in detail with reference to the foregoing embodiments, for those skilled in the art, the technical scheme described in the foregoing embodiments can still be modified or some technical features are replaced equivalently. Any modification, equivalent substitution, improvement, etc. made within the spirit and principle of the present disclosure should be included in the scope of protection of the present disclosure.

What is claimed is:

1. A device for measuring a thermal conductivity of high-temperature and high-pressure liquid, comprising a probe and a liquid flow channel, wherein the probe radially penetrates through the liquid flow channel, both ends of the probe extend out of the liquid flow channel and are installed and fixed via installation components, and the both ends of the probe are connected to a control system via wires;
the control system comprises a power supply, a voltmeter, an ammeter, a thermocouple and a flowmeter, wherein the power supply is used for energizing the probe, the voltmeter is used for measuring voltage at the both ends of the probe, the ammeter is used for measuring current flowing through the probe, the thermocouple is used for measuring temperature of the liquid, and the flowmeter is used for measuring a flow velocity of the liquid.

2. The device for measuring the thermal conductivity of high-temperature and high-pressure liquid according to claim 1, wherein the probe is made of tungsten metal or platinum metal and has a diameter of a range from 0.05 mm to 1 mm.

3. The device for measuring the thermal conductivity of high-temperature and high-pressure liquid according to claim 1, wherein each of the installation components comprises an adiabatic screw head, an end of the probe is inserted into the adiabatic screw head, a top of the adiabatic screw head is provided with a wiring hole, an outer side of the adiabatic screw head is sheathed with an alumina ceramic insulating shell, an outer side of the alumina ceramic insulating shell is sheathed with a metal shell, an external thread is formed on a lower end of the metal shell, and the lower end of the metal shell is threadedly connected with an internal thread hole preset on the liquid flow channel.

4. The device for measuring the thermal conductivity of high-temperature and high-pressure liquid according to claim 1, wherein a ratio of a length to a diameter of the liquid flow channel is not less than 15:1, and a distance between a position where the probe penetrates through the liquid flow channel and an entrance of the liquid flow channel is not less than 2/3 of a length of the liquid flow channel.

5. A method for measuring a thermal conductivity of high-temperature and high-pressure liquid, wherein a device for measuring a thermal conductivity of high-temperature and high-pressure liquid according to claim 1 is used, and the method comprising:
a, calibrating a temperature coefficient of resistance of the probe according to material of the probe;
b, installing the probe in the liquid flow channel by using the installation components, and sealing and fastening the probe;
c, connecting the probe with the control system via the wires, and starting the control system to energize the probe and keep current constant;
d, controlling the measured liquid to flow into the liquid flow channel and flow through the probe at a constant flow velocity, and keeping temperature and pressure unchanged during the controlling;
e, after data is stable, recording a voltage value, a current value and a liquid temperature value, and calculating and obtaining a resistance value according to the voltage value and the current value;
f, combining with a mathematical model to calculate and obtain the thermal conductivity of the measured liquid;
wherein the mathematical model comprises:
an equation of an average surface heat transfer coefficient of liquid on a surface of the probe: [symbol]
where constants C and n are constants related to a flow environment and Reynolds number in a heat transfer criterion number equation, experimental calibration values are selected and substituted for calculation,
$$Re = \frac{ρ u d}{μ}$$
is a dimensionless number that describes characteristics of liquid flow, and
$$P r = \frac{μ {C}_{p}}{λ}$$
is a dimensionless number that reflects interaction between energy and momentum transfer processes in fluid, which is determined by liquid physical parameters at a qualitative temperature;
according to a principle of heat balance, an amount of heat dissipation of a tungsten wire probe is equal to all heat generated due to flowing of the current through the probe without considering radiation heat transfer, and a heat dissipation equation is:
Q_{dissipation=}h·A·(T_{w-}T_{f})=I_{w}²R_{w}
where h is a convection heat transfer coefficient of a tungsten wire, A is a surface area of the liquid in contact with the probe, T_{w} is a surface temperature of the tungsten wire probe, T_{f} is a temperature of the liquid, I_{w} is current flowing through the probe, and R_{w} is a resistance value in a tungsten metal experiment;
a Nusselt number
$${N}_{μ} = \frac{h d}{λ}$$
is also known, where λ is a thermal conductivity of the fluid, and the equations are sorted to obtain: [symbol]
during measurement, a flow velocity u is measured by a flowmeter, a resistance value of the probe at this time is calculated by voltage and current signals in the control system, the temperature T_{w} at this time is conversed according to a corresponding relationship between a temperature and a resistance, a liquid temperature T_{f} is taken as a measurement temperature of a thermocouple at the entrance, the qualitative temperature
$${T}_{d} = \frac{{T}_{f} + {T}_{w}}{2}$$
is taken, after finding a physical parameter density ρ, a viscosity μ and a specific heat capacity Cₚ corresponding to the liquid to be measured at this qualitative temperature, only the thermal conductivity λ is left to be solved in the above equation, and the thermal conductivity λ is obtained by substituting the current and the resistance value.

6. The method for measuring the thermal conductivity of high-temperature and high-pressure liquid according to claim 5, wherein the device for measuring the thermal conductivity of high-temperature and high-pressure liquid is used for calibration by using water or n-decane, and an empirical equation and corresponding constants C and n which are more suitable for fine tungsten wires are obtained by fitting, so as to be used for calculation during measurement of high-temperature and high-pressure liquid.

7. The method for measuring the thermal conductivity of high-temperature and high-pressure liquid according to claim 5, wherein the probe is made of tungsten metal or platinum metal and has a diameter of a range from 0.05 mm to 1 mm.

8. The method for measuring the thermal conductivity of high-temperature and high-pressure liquid according to claim 7, wherein the device for measuring the thermal conductivity of high-temperature and high-pressure liquid is used for calibration by using water or n-decane, and an empirical equation and corresponding constants C and n which are more suitable for fine tungsten wires are obtained by fitting, so as to be used for calculation during measurement of high-temperature and high-pressure liquid.

9. The method for measuring the thermal conductivity of high-temperature and high-pressure liquid according to claim 5, wherein each of the installation components comprises an adiabatic screw head, an end of the probe is inserted into the adiabatic screw head, a top of the adiabatic screw head is provided with a wiring hole, an outer side of the adiabatic screw head is sheathed with an alumina ceramic insulating shell, an outer side of the alumina ceramic insulating shell is sheathed with a metal shell, an external thread is formed on a lower end of the metal shell, and the lower end of the metal shell is threadedly connected with an internal thread hole preset on the liquid flow channel.

10. The method for measuring the thermal conductivity of high-temperature and high-pressure liquid according to claim 9, wherein the device for measuring the thermal conductivity of high-temperature and high-pressure liquid is used for calibration by using water or n-decane, and an empirical equation and corresponding constants C and n which are more suitable for fine tungsten wires are obtained by fitting, so as to be used for calculation during measurement of high-temperature and high-pressure liquid.

11. The method for measuring the thermal conductivity of high-temperature and high-pressure liquid according to claim 5, wherein a ratio of a length to a diameter of the liquid flow channel is not less than 15:1, and a distance between a position where the probe penetrates through the liquid flow channel and an entrance of the liquid flow channel is not less than 2/3 of a length of the liquid flow channel.

12. The method for measuring the thermal conductivity of high-temperature and high-pressure liquid according to claim 11, wherein the device for measuring the thermal conductivity of high-temperature and high-pressure liquid is used for calibration by using water or n-decane, and an empirical equation and corresponding constants C and n which are more suitable for fine tungsten wires are obtained by fitting, so as to be used for calculation during measurement of high-temperature and high-pressure liquid.
